(19) United States
(12) Patent Application Publication
(10) Pub. No.: US 2026/0038761 A1
(43) Pub. Date: Feb. 5, 2026

(54) SUPERCONDUCTING CRYO MODULE

(71) Applicant: MITSUBISHI HEAVY INDUSTRIES MACHINERY SYSTEMS, LTD., Kobe-shi, Hyogo (JP)

(72) Inventors: Shu TAKAGI, Hyogo (JP); Nobuyuki SHIGEOKA, Hyogo (JP); Tomei SUGANO, Hyogo (JP); Hiroshi HARA, Hyogo (JP); Akihiro MIYAMOTO, Hyogo (JP); Katsuya SENNYU, Hyogo (JP); Ryuichi MATSUDA, Tokyo (JP)

(21) Appl. No.: 19/099,472

(22) PCT Filed: Jun. 1, 2023
(86) PCT No.: PCT/JP2023/020420

§ 371 Date: Jan. 29, 2025

(30) Foreign Application Priority Data
Aug. 4, 2022 (JP) 2022-124853

(51) Int. Cl. H01J 29/48; H01J 29/02; H05H 7/02

(52) U.S. Cl. CPC H01J 29/484; H01J 29/02; H01J 29/481; H05H 7/02; H05H 2007/025; H05H 2242/10

(57) ABSTRACT

Provided is a superconducting cryo module that can be made more compact. A superconducting cryo module according to the present disclosure comprises: a superconducting accelerating cavity that has a cell part accelerating electrons, a beam pipe part extending from the cell part to an electron incidence side, and an extraction part of the electrons which were accelerated by the cell part; and an electron gun that is located in the interior of the beam pipe part of the superconducting accelerating cavity, is located on the same axis as a beam axis BA of the superconducting accelerating cavity, and emits electrons into the cell part.

### TECHNICAL FIELD

The present disclosure relates to a superconducting cryomodule.

### BACKGROUND ART

The superconducting accelerator can operate at 4 K by forming a superconducting thin film on an inner surface of a superconducting accelerating cavity, and a large-scale cryogenic cooling system is not required. Therefore, it is possible to realize a reduction in introduction cost, a reduction in size of an apparatus, and the like. For example, PTL 1 discloses a superconducting acceleration radio-frequency cryomodule employing a heat transfer cooling system for performing cooling by connecting a cooling stage of a Gifford-McMahon refrigerator and a superconducting accelerating cavity with a heat transfer member.

### CITATION LIST

### Patent Literature

[PTL 1] PCT Japanese Translation Patent Publication No. 2021-507544

### SUMMARY OF INVENTION

However, in the superconducting acceleration radio-frequency cryomodule described in PTL 1, a size of the superconducting acceleration radio-frequency cryomodule is large because an incidence beam pipe and an outgoing beam pipe are provided outside the superconducting accelerating cavity. The present disclosure has been made in view of the above-described problems, and an object of the present disclosure is to provide a superconducting cryomodule capable of achieving a reduction in size.

### Solution to Problem

In order to solve the above-described problems and achieve the object, a superconducting cryomodule according to the present disclosure includes: a superconducting accelerating cavity that has a cell part accelerating electrons, a beam pipe part extending from the cell part to an incidence side of the electrons, and an extraction part of the electrons accelerated by the cell part; and an electron gun that is located inside the beam pipe part of the superconducting accelerating cavity and is located coaxially with a beam axis of the superconducting accelerating cavity, and that emits the electrons to the cell part.

According to the present disclosure, it is possible to provide a superconducting cryomodule capable of achieving a reduction in size.

### BRIEF DESCRIPTION OF DRAWINGS

FIG. 1 is an overall view of a superconducting accelerating cavity of a superconducting cryomodule according to the present disclosure.

FIG. 2 is a cross-sectional view taken along line A-A in FIG. 1 of the superconducting accelerating cavity of the superconducting cryomodule according to the present disclosure.

FIG. 3 is a schematic view showing a configuration example of an electron gun of the superconducting cryomodule according to the present disclosure.

### DESCRIPTION OF EMBODIMENTS

Hereinafter, embodiments of the present disclosure will be described in detail with reference to the drawings. The present disclosure is not limited to the embodiments described below.

### First Embodiment

### Configuration of Superconducting Cryomodule

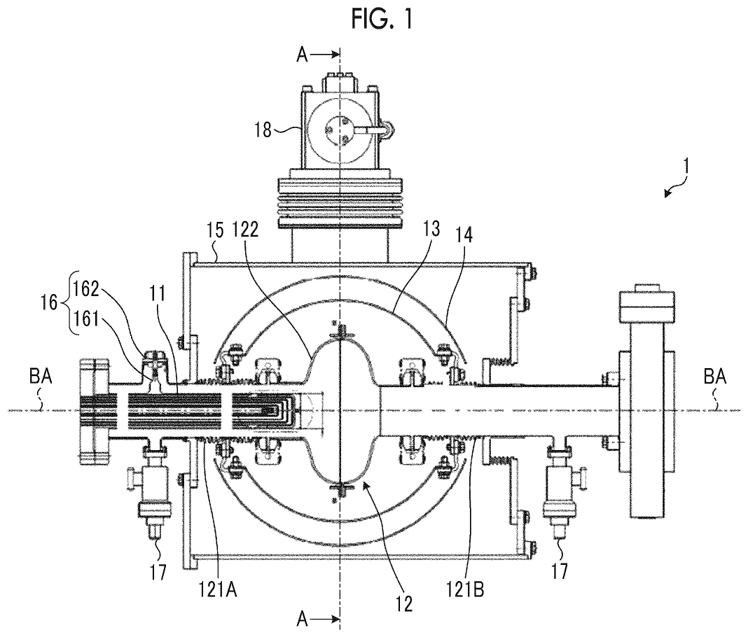

FIG. 1 is a schematic view showing a configuration example of a superconducting cryomodule according to the present disclosure. As shown in FIG. 1, a superconducting cryomodule 1 includes an electron gun 11, a superconducting accelerating cavity 12, a heat shield 13, a magnetic shield 14, a vacuum chamber 15, a radio frequency (RF) input coupler 16, a vacuum valve 17, and a cooler 18.

The electron gun 11 is located inside a beam pipe part 121 of the superconducting accelerating cavity 12 and is located coaxially with a beam axis BA of the superconducting accelerating cavity 12 to emit electrons to a cell part 122. In the present embodiment, the beam axis BA is a central axis of the superconducting accelerating cavity 12. In the superconducting accelerating cavity 12, the electrons move along the beam axis BA. In the superconducting cryomodule 1 according to the first embodiment, a thermionic emission type electron gun is used as the electron gun 11. In the thermionic emission type electron gun, a cathode is heated to emit free electrons from a metal forming the cathode, and the emitted electrons are extracted by an electric potential applied to an anode to emit the electrons. A configuration of the electron gun 11 will be described later.

The superconducting accelerating cavity 12 is a cavity that is formed of a material exhibiting superconductivity and accelerates electrons by an electric field formed by applying radio-frequency power. The superconducting accelerating cavity 12 is generally made of, for example, high-purity niobium. The energy of an electromagnetic field supplied by the radio-frequency power is consumed by resistive heating of a metal constituting a cavity wall of the superconducting accelerating cavity 12. Therefore, by setting the metal constituting the cavity wall of the superconducting accelerating cavity 12 to a superconducting state, it is possible to suppress the resistive heating and suppress an energy loss of the electromagnetic field. Since the high-purity niobium exhibits a superconducting state at 9.2 K, it is suitable for a material of the superconducting accelerating cavity 12.

The superconducting accelerating cavity 12 has the cell part 122 that accelerates electrons, a beam pipe part 121A that extends from the cell part 122 to an electron incident side, and an extraction part 121B that emits the electrons accelerated by the cell part 122. The beam pipe part 121A is connected to the cell part 122, and the electron gun 11 is disposed in the beam pipe part 121A so as to be coaxial with the beam axis BA. The beam pipe part 121A has a tubular shape and functions as an electron inlet into the cell part 122. A shape of the cell part 122 is determined such that an energy loss of the radio-frequency power in the cavity wall of the superconducting accelerating cavity 12 is reduced. The cell part 122 may be formed in, for example, an elliptical shape. The extraction part 121B is connected to the cell part 122, and the electrons accelerated in the cell part 122 flow into the extraction part 121B. The extraction part 121B emits the flowed-in electrons to the outside. The extraction part 121B may be formed in, for example, a tubular shape.

The heat shield 13 blocks thermal radiation radiated from the vacuum chamber 15 or the like in a room temperature atmosphere to the superconducting accelerating cavity 12. The heat shield 13 may be formed of oxygen-free copper. The oxygen-free copper exhibits a high value of thermal conductivity of 391 W/mK. Therefore, in a case where the oxygen-free copper is used for the heat shield 13, even though the thermal radiation is absorbed, a temperature of the heat shield 13 can be maintained at a low temperature by the cooler 18 connected to the heat shield 13.

The magnetic shield 14 is formed of a material that absorbs a magnetic field, and absorbs an environmental magnetic field existing outside the superconducting accelerating cavity 12. The magnetic shield 14 may be formed to cover the outside of the heat shield 13, for example. The magnetic shield 14 functions to attract magnetic flux lines of a magnetic field that can be an environmental magnetic field and to keep an unnecessary magnetic field away from a low temperature part. That is, the magnetic shield 14 forms a passage of the magnetic field to block a magnetic field such as geomagnetism such that the magnetic field does not flow into the magnetic shield 14 from the outside of the magnetic shield 14. The magnetic shield 14 is formed of a metal having a high magnetic permeability. The magnetic shield 14 may be formed of, for example, permalloy which is a nickel-iron alloy containing 35% to 85% of nickel.

The vacuum chamber 15 is a vacuum vessel of which the inside is kept in a vacuum state. Inside the vacuum chamber 15, the superconducting accelerating cavity 12, the heat shield 13, and the magnetic shield 14 are disposed in this order from an inner side to an outer side of the vacuum chamber 15. By keeping the inside of the vacuum chamber 15 in a vacuum state, it is possible to reduce thermal radiation and conductive heat into those components inside the vacuum chamber 15 from the outside of the vacuum chamber 15.

An RF input coupler 16 is connected to an accelerating power supply source and supplies radio-frequency power to the superconducting accelerating cavity 12 from the accelerating power supply source. The RF input coupler 16 includes a central portion 161 connected to an outermost shell (outer wall portion 117) of the electron gun 11 and an outer peripheral portion 162 connected to the beam pipe part 121A. The RF input coupler 16 propagates the radio-frequency power from the accelerating power supply source to the superconducting accelerating cavity 12 by a coaxial structure formed by the beam pipe part 121A as an outer conductor and the outermost shell of the electron gun 11 as an inner conductor. The accelerating power supply source may be a radio-frequency power supply source that achieves amplification of radio-frequency power by a vacuum tube such as an inductive output tube (IOT) or a klystron. In addition, the accelerating power supply source may achieve amplification of radio-frequency power by a semiconductor amplifier such as a field effect transistor (FET). In addition, the accelerating power supply source may be connected to a low level radio frequency (LLRF) control system to control a frequency of the radio-frequency power and the like. In addition, a circulator to which a port is connected may be provided between the accelerating power supply source and the RF input coupler 16 to prevent the radio-frequency power reflected from the superconducting accelerating cavity 12 from returning. That is, the RF input coupler 16, the accelerating power supply source, the LLRF control system, and the circulator constitute accelerating power supply equipment.

The vacuum valve 17 is a valve that maintains the inside of the superconducting accelerating cavity 12 in a vacuum state. A vacuum pump is connected to the vacuum valve 17 and air inside the superconducting accelerating cavity 12 is evacuated to create a vacuum using the vacuum pump. Thereafter, the vacuum valve 17 is closed to prevent inflow of air from the outside and to maintain a pressure inside the superconducting accelerating cavity 12 at an appropriate pressure.

The cooler 18 is connected to the superconducting accelerating cavity 12 to cool the superconducting accelerating cavity 12. As the cooler 18, a mechanical refrigerator such as a Gifford-McMahon refrigerator can be used. The Gifford-McMahon refrigerator achieves cooling by sending a refrigerant such as helium gas compressed by a compressor into a cylinder and repeatedly performing adiabatic expansion of a refrigerant gas by reciprocating movement of a displacer in the cylinder. On the other hand, a liquified helium refrigerator has a complicated configuration such as a helium liquefier, and requires an extremely large facility. The Gifford-McMahon refrigerator can be reduced in size by using a simple mechanical configuration such as a compressor or a displacer.

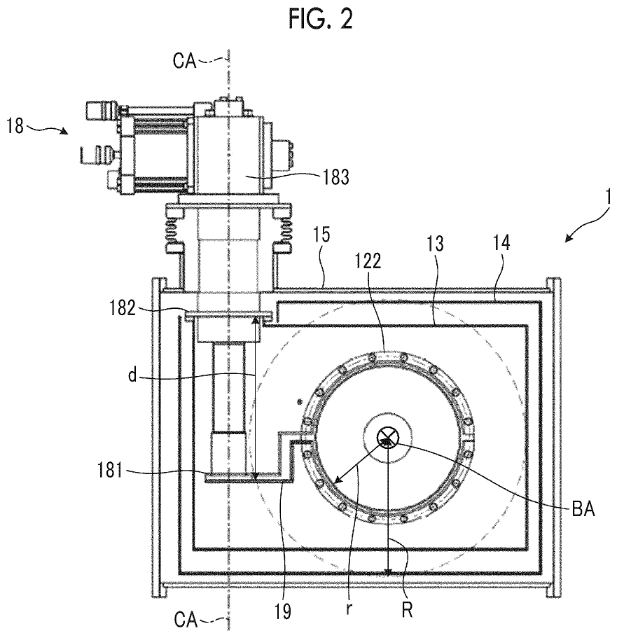

Here, a connecting portion between the cooler 18 and the superconducting accelerating cavity 12 will be described with reference to FIG. 2. FIG. 2 is a cross-sectional view taken along line A-A of the superconducting accelerating cavity of the superconducting cryomodule according to the present disclosure. As shown in FIG. 2, the cooler 18 includes a first stage 181, a second stage 182, and a cold head 183. The first stage 181 refers to a stage of the cooler 18 on a lower temperature side, and the second stage 182 refers to a stage of the cooler 18 on a higher temperature side. The cold head 183 is a portion for obtaining cooling by the expansion of the refrigerant supplied from the compressor.

As shown in FIG. 2, the first stage 181 is provided with a connecting portion 19 and is connected to the superconducting accelerating cavity 12 by the connecting portion 19. The connecting portion 19 may be formed in a flange shape. As shown in FIG. 2, the cooler 18 is disposed at a position where an angle between a central axis CA of the cooler 18 and the beam axis BA of the superconducting accelerating cavity 12 is a right angle, and the central axis CA and the beam axis BA are at positions skewed from each other. That is, the central axis CA of the cooler 18 and the beam axis BA of the superconducting accelerating cavity 12 are disposed at positions that do not intersect each other. With this, in a case where a cylindrical radius of the vacuum chamber 15 is represented by R, a radius of the superconducting accelerating cavity 12 is represented by r, and a distance between the first stage 181 and a connecting portion of the second stage 182 of the cooler 18 is represented by d, the cylindrical radius R of the vacuum chamber 15 can satisfy the following Expression (1).

$$R < r + d \qquad Expression ( 1 )$$

Therefore, it is possible to reduce a size of the vacuum chamber 15.

### Configuration of Electron Gun

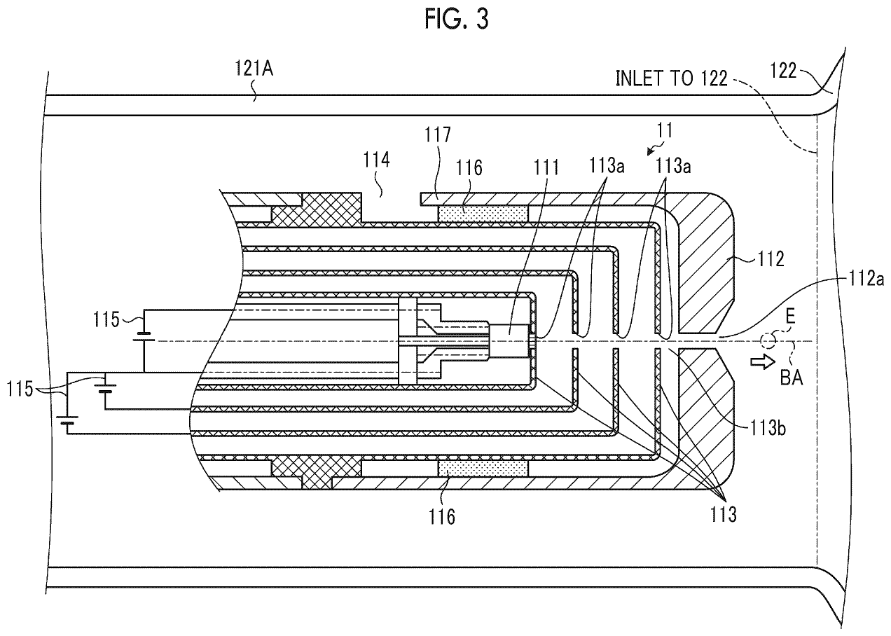

Next, a configuration of the electron gun 11 according to the present disclosure will be described with reference to FIG. 3. FIG. 3 is a diagram showing a first aspect of the electron gun of the superconducting cryomodule according to the present disclosure. As shown in FIG. 3, the electron gun 11 includes a cathode 111, an anode 112, a heat shielding plate portion 113, a cutout portion 114, and a power source 115.

The cathode 111 is formed of a metallic material and emits free electrons by being heated. The metallic material is composed of atoms in a stable closed-shell positive ion state and outer-shell electrons (free electrons) that can move freely between atoms. As a temperature of the metallic material increases, the energy of the free electrons increases, and the free electrons are emitted from the metallic material beyond a potential barrier. The cathode 111 emits electrons using such a principle. In addition, a tip portion of the cathode 111 is disposed at a position separated from an inlet portion of the cell part 122 to an upstream side in a direction in which the electrons move. As a result, it is possible to appropriately introduce the electrons from the electron gun 11 into the cell part 122.

The anode 112 extracts the electrons emitted from the cathode 111 by an electric potential and emits the electrons to the outside of the electron gun 11. A radio-frequency electric field is excited between the anode 112 and the heat shielding plate portion 113 by the radio-frequency power supplied from the RF input coupler 16, and the electrons emitted from the cathode 111 are accelerated.

The heat shielding plate portion 113 includes a plurality of metal plates formed around the cathode 111 that emits electrons. The plurality of metal plates of the heat shielding plate portion 113 may be formed of at least two layers of metal plates. In addition, the number of metal plates constituting the heat shielding plate portion 113 is not limited to two layers, and may be set to any number of layers. The heat shielding plate portion 113 is formed to cover the cathode 111, that is, to surround the cathode 111. For example, in a case where the cathode 111 has a cylindrical shape, the heat shielding plate portion 113 is formed in a cylindrical shape. In addition, a beam hole 113a through which the electron passes is formed in a tip portion of the heat shielding plate portion 113. The heat shielding plate portion 113 may be formed of a material that functions to shield heat. For example, the heat shielding plate portion 113 may be formed of oxygen-free copper.

The cutout portion 114 is a portion where a part of the outer wall portion 117 of the anode 112 is cut out. The cutout portion 114 is provided at a position where acceleration power can be supplied at a timing at which the electrons pass through the beam hole 112a of the anode 112. A shape of the cutout portion 114 may be a hole or a cylindrical slit. Accordingly, the radio-frequency power is induced into the electron gun 11 from the cutout portion 114. The induced radio-frequency power propagates inside a coaxial structure formed between an inner wall of the anode 112 and an outermost layer of the heat shielding plate portion 113, and excites a radio-frequency acceleration electric field in a space 113b between the beam hole 112a of the anode 112 and the beam hole 113a of the heat shielding plate portion 113. As a result, initially accelerated electrons E are introduced into the cell part 122.

The power source 115 supplies an electric potential to the plurality of metal plates constituting the heat shielding plate portion 113. The power source 115 may be realized by, for example, a direct current (DC) power source. The power source 115 applies a positive or negative voltage to the plurality of metal plates with respect to an electric potential of the cathode 111. As a result, the electrons emitted from the cathode 111 can be focused and extracted. That is, the plurality of metal plates constituting the heat shielding plate portion 113 function as a Wehnelt electrode and an extraction grid.

A dielectric 116 is provided between the anode 112 and the metal plate constituting the heat shielding plate portion 113. The dielectric 116 may be formed of, for example, a ceramic material, a glass material, a plastic material, or the like. The dielectric 116 may be formed in a ring shape so as to cover an outer periphery of the metal plate. The dielectric 116 functions as an insulator with respect to a direct current, but exhibits a property of conducting electricity with respect to the radio-frequency power supplied from a radio-frequency power source. In addition, by providing the dielectric 116, a propagation time of the radio-frequency power to reach the beam hole 112a can be controlled.

An operation of the superconducting cryomodule 1 configured as described above will be described. By heating the cathode 111 of the electron gun 11, the electrons E (refer to FIG. 3) are emitted from the cathode 111. By applying a voltage between the cathode 111 and the metal plate by the power source 115, the emitted electrons E are outgoing from the electron gun 11. Since the heat shielding plate portion 113 surrounds the cathode 111, heat of the cathode 111 is prevented from being transferred to the cell part 122.

The electrons E outgoing from the electron gun 11 move inside the beam pipe part 121A toward the cell part 122 along the beam axis BA. The electrons E that have reached the cell part 122 are accelerated by the radio-frequency power supplied from the RF input coupler 16 in the cell part 122 and are emitted from the extraction part 121B. A part of the radio-frequency power supplied from the RF input coupler 16 is induced into the electron gun 11 from the cutout portion 114. As a result, the electrons E emitted from the cathode 111 are accelerated and extracted to the outside of the electron gun 11.

As described above, the superconducting cryomodule 1 according to the first embodiment includes the superconducting accelerating cavity 12 having the cell part 122 that accelerates electrons, the beam pipe part 121A that extends from the cell part 122 to an incident side of the electrons, and the extraction part 121B that emits the electrons accelerated in the cell part 122, and the electron gun 11 that is located inside the beam pipe part 121A of the superconducting accelerating cavity 12 and is located coaxially with the beam axis BA of the superconducting accelerating cavity 12 and that emits the electrons to the cell part 122.

With this configuration, the electron gun of the superconducting cryomodule 1 can be housed in the beam pipe part 121A of the superconducting accelerating cavity 12. Therefore, it is not necessary to provide the electron gun 11 outside the superconducting cryomodule 1 and to connect the electron gun 11. As a result, it is possible to reduce a size of the entire apparatus.

### Second Embodiment

Next, the superconducting cryomodule 1 according to a second embodiment will be described. The superconducting cryomodule 1 according to the second embodiment has the same configuration as the superconducting cryomodule 1 according to the first embodiment, except that the configuration of the electron gun 11 is different. Therefore, in the configuration of the superconducting cryomodule 1 according to the second embodiment, the configuration of the electron gun 11 which is different from that of the superconducting cryomodule 1 according to the first embodiment will be described.

The electron gun 11 is a field emission type electron gun, and includes an emitter, an extraction electrode, and an acceleration electrode. The electron gun 11 extracts electrons emitted from the emitter by an extraction voltage and accelerates the electrons by an acceleration voltage of the acceleration electrode. The field emission type electron gun emits the electrons using a field emission phenomenon that occurs in a case where a high electric field is applied to a metal surface. Specifically, in a case where a voltage of several kV is applied to the extraction electrode disposed at a position facing the emitter, the electrons are emitted from the emitter by a tunnel effect. The electrons passing through a hole formed in a center of the extraction electrode can be emitted with a predetermined energy by the acceleration voltage applied to the acceleration electrode.

With this configuration, the electron gun 11 can be provided inside the superconducting accelerating cavity 12, and thus it is possible to reduce a size of the superconducting cryomodule 1.

### Third Embodiment

Next, the superconducting cryomodule 1 according to a third embodiment will be described. The superconducting cryomodule 1 according to the third embodiment has the same configuration as the superconducting cryomodule 1 according to the first embodiment, except that the configuration of the electron gun 11 is different. Therefore, in the configuration of the superconducting cryomodule 1 according to the third embodiment, the configuration of the electron gun 11 which is different from that of the superconducting cryomodule 1 according to the first embodiment will be described.

The electron gun 11 is a photoelectric emission type electron gun which emits electrons using a photoelectric effect. The photoelectric effect is a phenomenon in which a substance inhales photons and emits electrons. For example, in a case where a metal is irradiated with laser light having a short wavelength, electrons are emitted from a metal surface. For the cathode of the photoelectric emission type electron gun, a material having a high quantum efficiency, which means an efficiency of conversion between photons and electrons by the photoelectric effect, can be used.

With this configuration, the electron gun 11 can be provided inside the superconducting accelerating cavity 12, and thus it is possible to reduce a size of the superconducting cryomodule 1.

### Configuration and Effect

A superconducting cryomodule according to a first aspect of the present disclosure is the superconducting cryomodule 1 including: the superconducting accelerating cavity 12 having the cell part 122 that accelerates electrons, the beam pipe part 121A that extends from the cell part 122 to an incident side of the electrons, and the extraction part 121B that emits the electrons accelerated in the cell part 122, and the electron gun 11 that is located inside the beam pipe part 121A of the superconducting accelerating cavity 12 and is located coaxially with the beam axis BA of the superconducting accelerating cavity 12 and that emits the electrons to the cell part 122.

With this configuration, the electron gun of the superconducting cryomodule 1 can be housed in the beam pipe part 121A of the superconducting accelerating cavity 12. Therefore, it is not necessary to provide the electron gun 11 outside the superconducting cryomodule 1 and to connect the electron gun 11. As a result, it is possible to reduce a size of the entire apparatus.

A superconducting cryomodule according to a second aspect of the present disclosure is the superconducting cryomodule 1 according to the first aspect, in which the electron gun 11 is a thermionic emission type electron gun, and the electron gun 11 includes the heat shielding plate portion 113 in which a beam hole through which the electrons pass is formed around a cathode that emits the electrons and a plurality of metal plates are formed to surround the cathode.

With this configuration, it is possible to prevent the thermal radiation from the cathode of the thermionic emission type electron gun from being transferred to the superconducting accelerating cavity 12. Therefore, since it is possible to maintain a temperature of the superconducting accelerating cavity 12 at a low temperature, it is possible to maintain the superconducting accelerating cavity 12 in a superconducting state, and the superconducting cryomodule 1 can operate stably.

A superconducting cryomodule 1 according to a third aspect of the present disclosure is the superconducting cryomodule according to the first or second aspect, further including an RF input coupler that supplies radio-frequency power to the superconducting accelerating cavity 12, in which the RF input coupler 16 includes a central portion 161 connected to an outermost shell of the electron gun 11, and an outer peripheral portion 162 connected to the beam pipe part 121A, and the radio-frequency power is propagated to the superconducting accelerating cavity 12 by a coaxial structure formed by the beam pipe part 121A as an outer conductor and the outermost shell of the electron gun 11 as an inner conductor.

With this configuration, it is possible to supply the radio-frequency power from the RF input coupler 16 to the coaxial structure formed by the beam pipe part 121A as an outer conductor and the outermost shell of the electron gun 11 as an inner conductor. Therefore, it is possible to accelerate the electrons emitted from the electron gun 11 with the radio-frequency power and introduce the electrons into the cell part 122.

A superconducting cryomodule according to a fourth aspect of the present disclosure is the superconducting cryomodule 1 according to the third aspect, in which the electron gun 11 further includes the cutout portion 114 formed by cutting out a part of an anode, radio-frequency power that applies an electric field to the electrons emitted from a cathode of the electron gun 11 is supplied through the cutout portion 114, and extraction and acceleration of the electrons emitted from the cathode of the electron gun 11 are controlled by controlling the radio-frequency power.

With this configuration, since the radio-frequency power is supplied from the cutout portion 114, it is possible to control a beam by applying the electric field to the electrons emitted from the cathode of the electron gun 11.

A superconducting cryomodule according to a fifth aspect of the present disclosure is the superconducting cryomodule 1 according to any one of the second to fourth aspects, in which the electron gun 11 includes the dielectric 116 between the anode 112 and the metal plate constituting the heat shielding plate portion 113.

With this configuration, it is possible to control the propagation time of the radio-frequency power by the dielectric 116. Therefore, it is possible to emit the electrons from the electron gun 11 to the superconducting accelerating cavity 12 at an appropriate timing in accordance with a periodic variation of the radio-frequency power of the superconducting accelerating cavity 12.

A superconducting cryomodule according to a sixth aspect of the present disclosure is the superconducting cryomodule 1 according to the first aspect, in which the electron gun 11 is a field emission type electron gun and includes an emitter, an extraction electrode, and an acceleration electrode, and the electron gun 11 extracts the electrons emitted from the emitter by an extraction voltage and accelerates the electrons by an acceleration voltage of the acceleration electrode.

With this configuration, the electron gun 11 of the superconducting cryomodule 1 can be housed in the beam pipe part 121 of the superconducting accelerating cavity 12. Therefore, it is not necessary to provide the electron gun 11 outside the superconducting cryomodule I and to connect the electron gun 11. As a result, it is possible to reduce a size of the entire apparatus.

A superconducting cryomodule 1 according to a seventh aspect of the present disclosure is the superconducting cryomodule 1 according to the first aspect, in which the electron gun 11 is a photoelectric emission type electron gun, and a cathode is irradiated with laser to emit the electrons using a photoelectric effect.

With this configuration, the electron gun 11 of the superconducting cryomodule 1 can be housed in the beam pipe part 121 of the superconducting accelerating cavity 12. Therefore, it is not necessary to provide the electron gun 11 outside the superconducting cryomodule 1 and to connect the electron gun 11. As a result, it is possible to reduce a size of the entire apparatus.

A superconducting cryomodule according to an eighth aspect of the present disclosure is the superconducting cryomodule 1 according to the first aspect, in which a tip portion of a cathode of the electron gun 11 is disposed at a position separated from an inlet portion of the cell part 122 to an upstream side in a direction in which the electrons move.

With this configuration, since the electrons emitted from the electron gun 11 can be introduced into the cell part 122, the electrons emitted from the electron gun 11 can be appropriately accelerated in the cell part 122 to which the radio-frequency power is applied.

A superconducting cryomodule 1 according to a ninth aspect of the present disclosure is the superconducting cryomodule 1 according to the first aspect, further including the cooler 18 that is connected to the superconducting accelerating cavity 12 and cools the superconducting accelerating cavity 12, in which the cooler 18 has the connecting portion 19 connected to the superconducting accelerating cavity 12, and the cooler 18 is disposed at a position where an angle between the central axis CA of the cooler 18 and the beam axis BA of the superconducting accelerating cavity 12 is a right angle, and the central axis CA and the beam axis BA are at positions skewed from each other.

With this configuration, it is possible to shorten a height and a width of the vacuum chamber 15 that houses the superconducting accelerating cavity 12 and the like. Therefore, it is possible to reduce the size of the superconducting cryomodule 1.

Although the embodiments of the present invention have been described above, the embodiments are not limited by the contents of the embodiments. In addition, the above-described components include those that can be easily conceived by those skilled in the art, those that are substantially the same, and those that are within a so-called equivalent range. Further, the above-described components can be combined as appropriate. Further, various omissions, replacements, and modifications of the above-described components can be made without departing from the concept of the above-described embodiments.

### REFERENCE SIGNS LIST

1: superconducting cryomodule
11: electron gun
111: cathode
112: anode
113: heat shielding plate portion
114: cutout portion
115: power source
12: superconducting accelerating cavity
13: beat shield
14: magnetic shield
15: vacuum chamber
16: RE input coupler
17: vacuum valve
18: cooler
181: first stage
182: second stage
183: cold head
19: connecting portion
BA: beam axis
CA: central axis

1. A superconducting cryomodule comprising:
a superconducting accelerating cavity that has a cell part accelerating electrons, a beam pipe part extending from the cell part to an incidence side of the electrons, and an extraction part of the electrons accelerated by the cell part; and
an electron gun that is located inside the beam pipe part of the superconducting accelerating cavity and is located coaxially with a beam axis of the superconducting accelerating cavity, and that emits the electrons to the cell part.

2. The superconducting cryomodule according to claim 1,
wherein the electron gun is a thermionic emission type electron gun, and
the electron gun includes a heat shielding plate portion in which a beam hole through which the electrons pass is formed around a cathode that emits the electrons and a plurality of metal plates are formed to surround the cathode.

3. The superconducting cryomodule according to claim 1, further comprising:
an RF input coupler that supplies radio-frequency power to the superconducting accelerating cavity,
wherein the RF input coupler includes a central portion connected to an outermost shell of the electron gun, and an outer peripheral portion connected to the beam pipe part, and
the radio-frequency power is propagated to the superconducting accelerating cavity by a coaxial structure formed by the beam pipe part as an outer conductor and the outermost shell of the electron gun as an inner conductor.

4. The superconducting cryomodule according to claim 3,
wherein the electron gun further includes a cutout portion formed by cutting out a part of an anode,
radio-frequency power that applies an electric field to the electrons emitted from a cathode of the electron gun is supplied through the cutout portion, and
extraction and acceleration of the electrons emitted from the cathode of the electron gun are controlled by controlling the radio-frequency power.

5. The superconducting cryomodule according to claim 2,
wherein the electron gun includes a dielectric between an anode and the metal plate constituting the heat shielding plate portion.

6. The superconducting cryomodule according to claim 3,
wherein the electron gun includes a dielectric between an anode and a metal plate constituting the heat shielding plate portion.

7. The superconducting cryomodule according to claim 1,
wherein the electron gun is a field emission type electron gun and includes an emitter, an extraction electrode, and an acceleration electrode, and
the electron gun extracts the electrons emitted from the emitter by an extraction voltage and accelerates the electrons by an acceleration voltage of the acceleration electrode.

8. The superconducting cryomodule according to claim 1,
wherein the electron gun is a photoelectric emission type electron gun, and
a cathode is irradiated with laser to emit the electrons using a photoelectric effect.

9. The superconducting cryomodule according to claim 1,
wherein a tip portion of a cathode of the electron gun is disposed at a position separated from an inlet portion of the cell part to an upstream side in a direction in which the electrons move.

10. The superconducting cryomodule according to claim 1, further comprising:
a cooler that is connected to the superconducting accelerating cavity and cools the superconducting accelerating cavity,
wherein the cooler has a connecting portion connected to the superconducting accelerating cavity, and
the cooler is disposed at a position where an angle between a central axis of the cooler and the beam axis of the superconducting accelerating cavity is a right angle, and the central axis and the beam axis are at positions skewed from each other.

11. The superconducting cryomodule according to claim 4,
wherein the electron gun includes a dielectric between an anode and the metal plate constituting the heat shielding plate portion.
